(19) United States
(12) Patent Application Publication
(10) Pub. No.: US 2022/0093938 A1
(43) Pub. Date: Mar. 24, 2022

(54) ULTRA-LOW TEMPERATURE AND HIGH-CAPACITY PRIMARY LITHIUM BATTERY AND PREPARATION METHOD THEREOF

(71) Applicant: Long Power Systems (Nantong) Co.,Ltd., Nantong (CN)

(72) Inventors: Biying HUANG, Nantong (CN); Richard Brian HUANG, Nantong (CN); Tianwen TANG, Nantong (CN)

(21) Appl. No.: 17/540,663

(22) Filed: Dec. 2, 2021

(30) Foreign Application Priority Data
Dec. 5, 2020 (CN) 202011408357.5

(51) Int. Cl. H01M 6/02; H01M 50/406; H01M 50/417; H01M 4/08; H01M 6/16; H01M 50/119; H01M 4/62; H01M 50/536; H01M 4/66; H01M 4/74

(52) U.S. Cl. CPC H01M 6/02; H01M 50/406; H01M 50/417; H01M 4/08; H01M 6/164; H01M 6/166; H01M 2300/0025; H01M 4/625; H01M 4/622; H01M 50/536; H01M 4/661; H01M 4/74; H01M 50/119

(57) ABSTRACT

An ultra-low temperature and high-capacity primary lithium battery and a preparation method thereof. The primary lithium battery includes a dry cell, an electrolyte and a case. The battery is made by placement of the dry cell into the case, injection of the electrolyte, primary aging, sealing and secondary aging successively. The dry cell includes multiple unit sub-cells, and each unit sub-cell is repeated lamination of a positive plate, separator, a negative plate and another separator or lamination and winding. All unit sub-cells are enclosed such that the heat generated by the primary lithium battery during operation circulates inside the battery.

### CROSS-REFERENCE TO RELATED APPLICATIONS

This application claims the benefit of priority from Chinese Patent Application No. 202011408357.5, filed on Dec. 5, 2020. The content of the aforementioned application, including any intervening amendments thereto, is incorporated herein by reference in its entirety.

### TECHNICAL FIELD

The present disclosure relates to primary lithium battery, and more particularly to an ultra-low temperature and high-capacity primary lithium battery and a preparation method thereof.

### BACKGROUND

Primary lithium batteries have been widely used in the market due to their advantages of high voltage plateau, large energy density, low self-discharge rate and superior storage performance. However, when used at a temperature below −50° C., the operating voltage and current are extremely low, and the discharge capacity retention rate is also difficult to improve.

To solve this problem, in addition to improving and optimizing the battery materials, it is also needed to optimize the preparation process to increase the working voltage, current, and discharge capacity retention rate of the primary lithium battery at an ultra-low temperature to meet special requirements. Based on this, the present disclosure provides an ultra-low temperature and high-capacity primary lithium battery and a preparation method thereof.

### SUMMARY

In order to overcome the above-described problem, the present disclosure provides a primary lithium battery and a preparation method thereof. In the primary lithium battery provided herein, the unit sub-cells are enclosed such that the heat generated by the primary lithium battery is retained therein to the largest extent. The internal circulation of heat increases the battery temperature during operation, which facilitates enhancing the activity of lithium ions in the battery, improving the working voltage, current and discharge capacity retention rate of the primary lithium battery in the ultra-low temperature environment.

The technical solutions of the present disclosure are described as follows.

In a first aspect, the disclosure provides a primary lithium battery, comprising:
a dry cell;
an electrolyte; and
a case;
wherein the primary lithium battery is prepared by placement of the dry cell into the case, injection of the electrolyte, primary aging, sealing and secondary aging successively; the dry cell comprises a plurality of unit sub-cells; each of the plurality of unit sub-cells is formed by repeated lamination of a positive plate, a separator, a negative plate and another separator or by repeated lamination and winding; the plurality of unit sub-cells are enclosed such that heat generated by the primary lithium battery during operation circulates inside the primary lithium battery;
the positive plate comprises a cathode material, a first conductive agent, a first binder and an aluminum foil current collector or an aluminum mesh current collector with a first reserved tab; and the positive plate is manufactured by pulping, coating, drying, rolling and sheeting in sequence;
the negative plate comprises an anode material, a second conductive agent, a second binder and a copper foil current collector or a copper mesh current collector with a second reserved tab; and the negative plate is manufactured by pulping, coating, drying, rolling and sheeting in sequence;
the separator is made of polypropylene, polyethylene or a combination thereof; and the separator is manufactured by stirring, mixing, cooling, extension, drawing out, drying and slitting;
the electrolyte comprises a lithium salt and an organic solvent; the organic solvent is a carbonate, a carboxylate, an ether or a combination thereof; the lithium salt is selected from the group consisting of the lithium perchlorate, anhydrous lithium tetrachloroaluminate, lithium hexafluorophosphate, lithium tetrafluoroborate, lithium bis(oxalate)borate, lithium oxalyldifluoroborate, lithium bis(fluorosulfonyl)imide, lithium bis(trifluoromethanesulfonyl)imide, lithium trifluoromethanesulfonate, lithium iodide and a combination thereof; the carbonate is selected from the group consisting of ethylene carbonate, propylene carbonate, 2,3-butylene carbonate, fluoroethylene carbonate, vinylene carbonate, dimethyl carbonate, ethyl methyl carbonate, diethyl carbonate and a combination thereof; the carboxylate is selected from the group consisting of methyl formate, ethyl formate, propyl formate, butyl formate, methyl acetate, ethyl acetate, propyl acetate, butyl acetate, methyl propionate, ethyl propanoate, propyl propionate, methyl butyrate, ethyl butyrate, propyl butyrate, 1,4-butyrolactone, δ-valerolactone and a combination thereof; and the ether is selected from the group consisting of 2-methyltetrahydrofuran, 1,3-dioxolane, 4-methyl-1,3-dioxolane, dimethoxymethane, 1,2-dimethoxyethane, diethylene glycol dimethyl ether and a combination thereof.

In some embodiments, the case is square or cylindrical, and is made of steel, aluminum or an aluminum-plastic material.

In some embodiments, the cathode material is selected from the group consisting of manganese dioxide, carbon-based manganese dioxide composite, sulfur, carbon-based sulfur composite, thionyl chloride and perfluorocarbon

In some embodiments, the first conductive agent and the second conductive agent are independently selected from the group consisting of superconductive carbon black, conductive graphite, carbon fiber, carbon nanotube, grapheme and a combination thereof.

In some embodiments, the first binder and the second binder are independently selected from the group consisting of polyvinylidene chloride, styrene butadiene rubber, sodium carboxymethylcellulose and a combination thereof.

In a second aspect, the disclosure provides a method for preparing the primary lithium battery, comprising:

(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a naked unit sub-cell; and covering an outer surface of the naked unit sub-cell with a film except for the positive sub-tab and the negative sub-tab to obtain a unit sub-cell;

(S2) welding positive sub-tabs of a plurality of unit sub-cells with a first metal sheet, and welding negative sub-tabs of the plurality of unit sub-cells with a second metal sheet to obtain a dry cell, wherein a part at an end of the first metal sheet is reserved to form a positive tab of the dry cell; a part at an end of the second metal sheet is reserved to form a negative tab of the dry cell; and the positive tab and the negative tab of the dry cell are respectively configured to be connected with an external current collector; and

(S3) placing the dry cell into the case followed by injection of the electrolyte, primary aging, sealing and secondary aging successively to produce the primary lithium battery.

In a third aspect, the disclosure provides another method for preparing the primary lithium battery, comprising:

(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a naked unit sub-cell; and covering an outer surface of the naked unit sub-cell with a polyethylene film or a polypropylene film except for the positive sub-tab and the negative sub-tab to obtain a unit sub-cell, wherein a first air hole or a first air slit is formed on surface of the polyethylene film or the polypropylene film at ends near and far away from the positive sub-tab, and a second air hole or a second air slit is formed on the surface of the polyethylene film or the polypropylene film at ends near and far away from the negative sub-tab;

(S2) welding a negative sub-tab of a first unit sub-cell of a plurality of unit sub-cells and a positive sub-tab of a second unit sub-cell of the plurality of unit sub-cells to a first metal sheet; welding a negative sub-tab of the second unit sub-cell and a positive sub-tab of a third unit sub-cell of the plurality of unit sub-cells to a second metal sheet; welding a negative sub-tab of the third unit sub-cell and a positive sub-tab of a fourth unit sub-cell of the plurality of unit sub-cells to a third metal sheet, and so on, such that the plurality of unit sub-cells are connected in series to obtain a dry cell; wherein a positive sub-tab of the first unit sub-cell is configured as a positive tab of the dry cell, and a negative sub-tab of the last unit sub-cell of the plurality of unit sub-cells is configured as a negative tab of the dry cell; and the positive tab and the negative tab of the dry cell are respectively configured to be connected to an external current collector; and

(S3) placing the dry cell into the case followed by injection of the electrolyte, primary aging, sealing and secondary aging successively to produce the primary lithium battery.

In a fourth aspect, the disclosure provides another method for preparing the primary lithium battery, comprising:

(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a naked unit sub-cell; and covering an outer surface of the naked unit sub-cell with a polyethylene film or a polypropylene film except for the positive sub-tab and the negative sub-tab to obtain a unit sub-cell, wherein a first air hole or a first air slit is formed on surface of the polyethylene film or the polypropylene film at ends near and far away from the positive sub-tab, and a second air hole or a second air slit is formed on the surface of the polyethylene film or the polypropylene film at ends near and far away from the negative sub-tab;

(S2) welding a negative sub-tab of a first unit sub-cell of a plurality of unit sub-cells and a positive sub-tab of a second unit sub-cell of the plurality of unit sub-cells to a first metal sheet; welding a negative sub-tab of the second unit sub-cell and a positive sub-tab of a third unit sub-cell of the plurality of unit sub-cells to a second metal sheet; welding a negative sub-tab of the third unit sub-cell and a positive sub-tab of a fourth unit sub-cell of the plurality of unit sub-cells to a third metal sheet, and so on, such that the plurality of unit sub-cells are connected in series to form a sub-cell set, wherein a positive sub-tab of the first unit sub-cell is configured as a positive branch-tab of the sub-cell set, and a negative sub-tab of the last unit sub-cell of the plurality of unit sub-cells is configured as a negative branch-tab of the sub-cell set;

(S3) welding positive branch-tabs of a plurality of sub-cell sets with a fourth metal sheet, and welding negative branch-tabs of the plurality of sub-cell sets with a fifth metal sheet to obtain a dry cell, wherein the plurality of sub-cell sets each have the same number of unit sub-cells; a part at an end of the fourth metal sheet is reserved to form a positive tab of the dry cell, and a part at an end of the fifth metal sheet is reserved to form a negative tab of the dry cell; and the positive tab and the negative tab of the dry cell are respectively configured to be connected with an external current collector; and

(S4) placing the dry cell into the case followed by injection of the electrolyte, primary aging, sealing and secondary aging successively to produce the primary lithium battery.

In a fifth aspect, the disclosure provides a method for preparing the primary lithium battery, comprising:

(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a unit sub-cell;

(S2) welding positive sub-tabs of a plurality of unit sub-cells with a first metal sheet, and welding negative sub-tabs of the plurality of unit sub-cells with a second metal sheet to obtain a naked sub-cell set, wherein a part at an end of the first metal sheet is reserved to form a positive branch-tab, and a part at an end of the second metal sheet is reserved to form a negative branch-tab; and covering an outer surface of the naked sub-cell set with a polyethylene film or a polypropylene film except for the positive branch-tab and the negative branch-tab to obtain a sub-cell set, wherein a first air hole or a first air slit is formed on surface of the polyethylene film or the polypropylene film at ends near and far away from the positive branch-tab, and a second air hole or a second air slit is formed on the surface of the polyethylene film or the polypropylene film at ends near and far away from the negative branch-tab;

(S3) welding a negative branch-tab of a first sub-cell set of a plurality of sub-cell sets and a positive branch-tab of a second sub-cell set of the plurality of sub-cell sets to a third metal sheet; welding a negative branch-tab of the second sub-cell set and a positive branch-tab of a third sub-cell set of the plurality of sub-cell sets to a fourth metal sheet; welding a negative branch-tab of the third sub-cell set and a positive branch-tab of a fourth sub-cell set of the plurality of sub-cell sets to a fifth metal sheet, and so on, such that the plurality of sub-cell sets are connected in series to obtain a dry cell, wherein the plurality of sub-cell sets each have the same number of unit sub-cells; a positive branch-tab of the first sub-cell set is configured as a positive tab of dry cell, and a negative branch-tab of the last sub-cell set is configured as a negative tab of the dry cell; and the positive tab and the negative tab are respectively configured to be connected with an external current collector; and

(S4) placing the dry cell into the case followed by injection of the electrolyte, primary aging, sealing and secondary aging successively to produce the primary lithium battery.

Compared to the prior art, the disclosure has the following beneficial effects.

In the primary lithium battery provided herein, the unit sub-cells are enclosed such that the heat generated by the primary lithium battery is retained therein to the largest extent (the maximum heat value reaches 50%-80%). The internal circulation of heat increases the battery temperature during operation, which facilitates enhancing the activity of lithium ions in the battery, improving the working voltage, current and discharge capacity retention rate of the primary lithium battery in the ultra-low temperature environment.

### BRIEF DESCRIPTION OF THE DRAWINGS

FIG. 1 shows a discharge capacity retention rate of a primary lithium battery according to an embodiment of the disclosure at −50° C./1 C. with respect to 25° C./1 C.

FIG. 2 is a structure diagram of a dry cell in the primary lithium battery according to an embodiment of the disclosure.

FIG. 3 is a structure diagram of the dry cell in the primary lithium battery according to another embodiment of the disclosure.

In the drawings, 100, dry cell; 110, unit sub-cell; 111, positive plate; 1111, positive sub-tab; 112, separator; 113, negative plate; 1131, negative sub-tab; 114, polyethylene film or polypropylene film; 120, positive tab; 130, negative tab; 140, metal sheet; and 200, case.

### DETAILED DESCRIPTION OF EMBODIMENTS

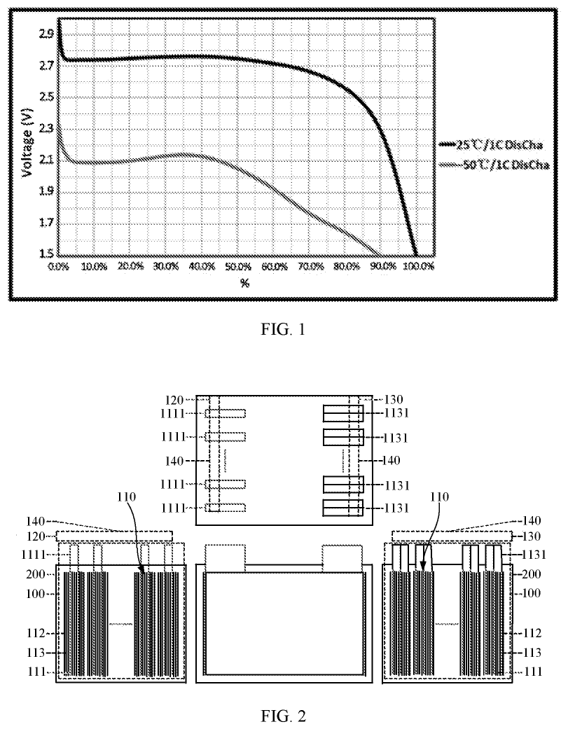

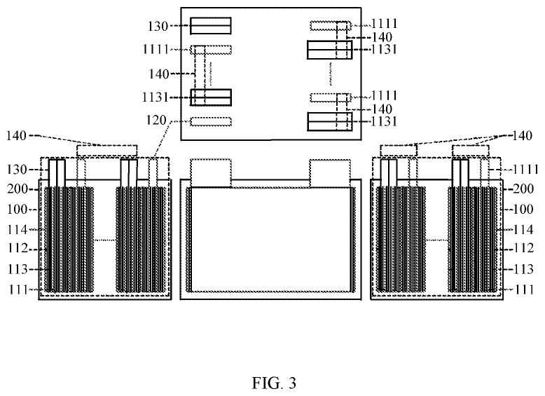

FIGS. 2-3 schematically illustrate a dry cell of an ultra-low temperature and high-capacity primary lithium battery in two embodiments, respectively. As shown in FIG. 1, the discharge capacity retention rate of the battery at −50° C./1 C. reaches more than 90% with respect to 25°C./1 C.

In an embodiment, a primary lithium battery includes a dry cell 100, an electrolyte and a case 200. The primary lithium battery is prepared by placement of the dry cell 100 into the case 4, injection of the electrolyte, primary aging, sealing and secondary aging successively. The dry cell 100 includes a plurality of unit sub-cells 110, and each unit sub-cell 110 is formed by repeated lamination of a positive plate 111, a separator 112, a negative plate 113 and another separator 112 or by repeated lamination and winding. The unit sub-cells 110 are enclosed such that heat generated by the primary lithium battery during operation circulates inside the primary lithium battery. The internal circulation of heat increases the battery temperature during operation, which facilitates enhancing the activity of lithium ions in the battery, improving the electrical properties of the primary lithium battery in the ultra-low temperature environment; and the ultra-low temperature environment is below −50°.

The positive plate 111 includes a cathode material, a first conductive agent, a first binder and an aluminum foil current collector or an aluminum mesh current collector with a first reserved tab, and is manufactured by pulping, coating, drying, rolling and sheeting in sequence.

The negative plate 113 includes an anode material, a second conductive agent, a second binder and a copper foil current collector or a copper mesh current collector with a second reserved tab, and is manufactured by pulping, coating, drying, rolling and sheeting in sequence.

The separator 112 is made of polypropylene, polyethylene or a combination thereof, and is manufactured by stirring, mixing, cooling, extension, drawing out, drying and slitting.

The electrolyte contains a lithium salt and an organic solvent, where the organic solvent is a carbonate, a carboxylate, an ether or a combination thereof, and the lithium salt is selected from the group consisting of the lithium perchlorate, anhydrous lithium tetrachloroaluminate, lithium hexafluorophosphate, lithium tetrafluoroborate, lithium bis(oxalate)borate, lithium oxalyldifluoroborate, lithium bis(fluorosulfonyl)imide, lithium bis(trifluoromethanesulfonyl)imide, lithium trifluoromethanesulfonate, lithium iodide and a combination thereof. The carbonate is selected from the group consisting of ethylene carbonate, propylene carbonate, 2,3-butylene carbonate, fluoroethylene carbonate, vinylene carbonate, dimethyl carbonate, ethyl methyl carbonate, diethyl carbonate and a combination thereof. The carboxylate is selected from the group consisting of methyl formate, ethyl formate, propyl formate, butyl formate, methyl acetate, ethyl acetate, propyl acetate, butyl acetate, methyl propionate, ethyl propanoate, propyl propionate, methyl butyrate, ethyl butyrate, propyl butyrate, 1,4-butyrolactone, δ-valerolactone and a combination thereof. The ether is selected from the group consisting of 2-methyltetrahydrofuran, 1,3-dioxolane, 4-methyl-1,3-dioxolane, dimethoxymethane, 1,2-dimethoxyethane, diethylene glycol dimethyl ether and a combination thereof.

In an embodiment, the case 200 is square or cylindrical, and is made of steel, aluminum or an aluminum-plastic material.

In an embodiment, the cathode material is selected from the group consisting of manganese dioxide, carbon-based manganese dioxide composite, sulfur, carbon-based sulfur composite, thionyl chloride and perfluorocarbon.

In an embodiment, the first conductive agent of the positive plate 111 and the second conductive agent of the negative plate 113 are independently selected from the group consisting of superconductive carbon black, conductive graphite, carbon fiber, carbon nanotube, grapheme and a combination thereof.

### Embodiment 1

Provided herein is a method for preparing an ultra-low temperature and high-capacity primary lithium battery, which is described as follows.

(S1) A plurality of positive plates 111, a plurality of negative plates 113 and a plurality of separators 112 are subjected to lamination in a manner of repeated “positive plate-separator-negative plate-separator” or to lamination and winding. Reserved tabs of the positive plates 111 are welded to form a positive sub-tab 1111, and reserved tabs of the negative plates 113 are welded to form a negative sub-tab 1131 to obtain a naked unit sub-cell 110. An outer surface of the naked unit sub-cell 110 except for the positive sub-tab 1111 and the negative sub-tab 1131 is covered with a film to obtain a unit sub-cell 110.

(S2) Positive sub-tabs 1111 of a plurality of unit sub-cells 110 are welded with a first metal sheet 140, and negative sub-tabs 1131 of the unit sub-cells 110 are welded with a second metal sheet 140 to obtain a dry cell 100, where a part at an end of the first metal sheet 140 is reserved to form a positive tab 120 of the dry cell 100; a part at an end of the second metal sheet 140 is reserved to form a negative tab 130 of the dry cell 100; and the positive tab 120 and the negative tab 130 of the dry cell 100 are respectively configured to be connected with an external current collector.

(S3) The dry cell 100 is placed into the case 200 followed by injection of the electrolyte, primary aging, sealing and secondary aging successively to produce the primary lithium battery.

### Embodiment 2

Provided herein is a method for preparing an ultra-low temperature and high-capacity primary lithium battery, which is described as follows.

(S1) A plurality of positive plates 111, a plurality of negative plates 113 and a plurality of separators 112 are subjected to lamination in a manner of repeated “positive plate-separator-negative plate-separator” or to lamination and winding. Reserved tabs of the positive plates 111 are welded to form a positive sub-tab 1111, and reserved tabs of the negative plates 113 are welded to form a negative sub-tab 1131 to obtain a naked unit sub-cell 110. An outer surface of the naked unit sub-cell 110 except for the positive sub-tab 1131 and the negative sub-tab 1111 is covered with a polyethylene film or a polypropylene film 114. A first air hole or a first air slit is formed on surface of the polyethylene film or the polypropylene film 114 at ends near and far away from the positive sub-tab 1111, and a second air hole or a second air slit is formed on the surface of the polyethylene film or the polypropylene film at ends near and far away from the negative sub-tab 1131.

(S2) A negative sub-tab 1131 of a first unit sub-cell 110 of a plurality of unit sub-cells and a positive sub-tab 1111 of a second unit sub-cell 110 of the plurality of unit sub-cells are welded with a first metal sheet 140. A negative sub-tab 1131 of the second unit sub-cell 110 and a positive sub-tab 1111 of a third unit sub-cell 110 of the plurality of unit sub-cells are welded with a second metal sheet 140. A negative sub-tab 1131 of the third unit sub-cell 110 and a positive sub-tab 1111 of a fourth unit sub-cell 110 of the plurality of unit sub-cells are welded with a third metal sheet 140, and so on, such that the plurality of unit sub-cells 110 are connected in series to obtain a dry cell 100, where a positive sub-tab 1111 of the first unit sub-cell 110 is configured as a positive tab 120 of the dry cell 100, and a negative sub-tab 1131 of the last unit sub-cell 100 of the plurality of unit sub-cells is configured as a negative tab 130 of the dry cell 100, and the positive tab 120 and the negative tab 130 of the dry cell 100 are respectively configured to be connected to an external current collector.

(S3) The dry cell 100 is placed into the case 200 followed by injection of the electrolyte, primary aging, sealing and secondary aging successively to produce the primary lithium battery.

### Embodiment 3

Provided herein is a method for preparing an ultra-low temperature and high-capacity primary lithium battery, which is described as follows.

(S1) A plurality of positive plates 111, a plurality of negative plates 113 and a plurality of separators 112 are subjected to lamination in a manner of repeated “positive plate-separator-negative plate-separator” or to lamination and winding. Reserved tabs of the positive plates 111 are welded to form a positive sub-tab 1111, and reserved tabs of the negative plates 113 are welded to form a negative sub-tab 1131 to obtain a naked unit sub-cell 110. An outer surface of the naked unit sub-cell 110 except for the positive sub-tab 1131 and the negative sub-tab 1111 is covered with a polyethylene film or a polypropylene film 114. A first air hole or a first air slit is formed on surface of the polyethylene film or the polypropylene film 114 at ends near and far away from the positive sub-tab 1111, and a second air hole or a second air slit is formed on the surface of the polyethylene film or the polypropylene film at ends near and far away from the negative sub-tab 1131.

(S2) A negative sub-tab 1131 of a first unit sub-cell 110 of a plurality of unit sub-cells and a positive sub-tab 1111 of a second unit sub-cell 110 of the plurality of unit sub-cells are welded with a first metal sheet 140. A negative sub-tab 1131 of the second unit sub-cell 110 and a positive sub-tab 1111 of a third unit sub-cell 110 of the plurality of unit sub-cells are welded with a second metal sheet 140. A negative sub-tab 1131 of the third unit sub-cell 110 and a positive sub-tab 1111 of a fourth unit sub-cell 110 of the plurality of unit sub-cells are welded with a third metal sheet 140, and so on, such that the plurality of unit sub-cells 110 are connected in series to form a sub-cell set, where a positive sub-tab 1111 of the first unit sub-cell 110 is configured as a positive branch-tab of the sub-cell set, and a negative sub-tab 1131 of the last unit sub-cell of the plurality of unit sub-cells 110 is configured as a negative branch-tab of the sub-cell set.

(S3) Positive branch-tabs of a plurality of sub-cell sets are welded with a fourth metal sheet 140, and negative branch-tabs of the plurality of sub-cell sets are welded with a fifth metal sheet 140 to obtain a dry cell 100, where the plurality of sub-cell sets each have the same number of unit sub-cells 110; a part at an end of the fourth metal sheet 140 is reserved to form a positive tab 120 of the dry cell 100, and a part at an end of the fifth metal sheet 140 is reserved to form a negative tab 130 of the dry cell 100; and the positive tab 120 and the negative tab 130 of the dry cell are respectively configured to be connected with an external current collector.

(S4) The dry cell 100 is placed into the case 200 followed by injection of the electrolyte, primary aging, sealing and secondary aging successively to produce the primary lithium battery.

### Embodiment 4

Provided herein is a method for preparing an ultra-low temperature and high-capacity primary lithium battery, which is described as follows.

(S1) A plurality of positive plates 111, a plurality of negative plates 113 and a plurality of separators 112 are subjected to lamination in a manner of repeated “positive plate-separator-negative plate-separator” or to lamination and winding. Reserved tabs of the positive plates 111 are welded to form a positive sub-tab 1111, and reserved tabs of the negative plates 113 are welded to form a negative sub-tab 1131 to obtain a naked unit sub-cell 110. An outer surface of the naked unit sub-cell 110 except for the positive sub-tab 1111 and the negative sub-tab 1131 is covered with a film to obtain a unit sub-cell 110.

(S2) Positive sub-tabs 1111 of a plurality of unit sub-cells 110 are welded with a first metal sheet 140, and negative sub-tabs 1131 of the plurality of unit sub-cells 110 are welded with a second metal sheet 140 to obtain a naked sub-cell set, where a part at an end of the first metal sheet 140 is reserved to form a positive branch-tab, and a part at an end of the second metal sheet 140 is reserved to form a negative branch-tab. An outer surface of the naked sub-cell set except for the positive branch-tab and the negative branch-tab is covered a polyethylene film or a polypropylene film 114 to obtain a sub-cell set, where a first air hole or a first air slit is formed on surface of the polyethylene film or the polypropylene film 114 at ends near and far away from the positive branch-tab, and a second air hole or a second air slit is formed on the surface of the polyethylene film or the polypropylene film at ends near and far away from the negative branch-tab.

(S3) A negative branch-tab of a first sub-cell set of a plurality of sub-cell sets and a positive branch-tab of a second sub-cell set of the plurality of sub-cell sets are welded with a third metal sheet 140; a negative branch-tab of the second sub-cell set and a positive branch-tab of a third sub-cell set of the plurality of sub-cell sets are welded with a fourth metal sheet 140; a negative branch-tab of the third sub-cell set and a positive branch-tab of a fourth sub-cell set of the plurality of sub-cell sets are welded with a fifth metal sheet 140, and so on, such that the plurality of sub-cell sets are connected in series to obtain a dry cell 100, where the plurality of sub-cell sets each have the same number of unit sub-cells 110; a positive branch-tab of the first sub-cell set is configured as a positive tab 120 of dry cell 100, and a negative branch-tab of the last sub-cell set is configured as a negative tab 130 of the dry cell 100; and the positive tab 120 and the negative tab 130 are respectively configured to be connected with an external current collector.

(S4) The dry cell 100 is placed into the case 200 followed by injection of the electrolyte, primary aging, sealing and secondary aging successively to produce the primary lithium battery.

In Embodiment 1, a plurality of unit sub-cells 110 are connected in parallel; in Embodiment 2, a plurality of unit sub-cells 110 are connected in series; in Embodiment 3, a plurality of unit sub-cells 110 are connected in series and then in parallel; and in embodiment 4, a plurality of unit sub-cells 110 are connected in parallel and then in series. In the present disclosure, the primary lithium battery is manufactured by series connection, parallel connection and combined series-parallel connection of unit sub-cells 110, and the unit sub-cells 110 are enclosed such that the heat generated by the primary lithium battery is retained therein to the largest extent. The internal circulation of heat increases the battery temperature during operation, which facilitates enhancing the activity of lithium ions in the battery, improving the working voltage, current and discharge capacity retention rate of the primary lithium battery in the ultra-low temperature environment.

The primary lithium battery is prepared by placement of the dry cell 100 into the case 200, injection of the electrolyte, primary aging, sealing and secondary aging successively. The primary aging and the secondary aging allow the moisture in the electrolyte to be fully reacted, rendering the chemical property of the primary lithium battery more stable and reducing the occurrence of swelling. As a consequence, the primary lithium battery can still maintain great cycle performance during the high-rate charging and discharging process, improving the working voltage, current and discharge capacity retention rate in the ultra-low temperature environment.

Described above are merely preferred embodiments of the disclosure, which are illustrative of the disclosure and are not intended to limit the disclosure. It should be noted that any changes, replacements and modifications made by those skilled in the art without departing from the spirit of the disclosure should fall within the scope of the disclosure defined by the appended claims.

What is claimed is:

1. A primary lithium battery, comprising:
a dry cell;
an electrolyte; and
a case;
wherein the primary lithium battery is prepared by placement of the dry cell into the case, injection of the electrolyte, primary aging, sealing and secondary aging successively; the dry cell comprises a plurality of unit sub-cells; each of the plurality of unit sub-cells is formed by repeated lamination of a positive plate, a separator, a negative plate and another separator or by repeated lamination and winding; the plurality of unit sub-cells are enclosed such that heat generated by the primary lithium battery during operation circulates inside the primary lithium battery;
the positive plate comprises a cathode material, a first conductive agent, a first binder and an aluminum foil current collector or an aluminum mesh current collector with a first reserved tab; and the positive plate is manufactured by pulping, coating, drying, rolling and sheeting in sequence;
the negative plate comprises an anode material, a second conductive agent, a second binder and a copper foil current collector or a copper mesh current collector with a second reserved tab; and the negative plate is manufactured by pulping, coating, drying, rolling and sheeting in sequence;
the separator is made of polypropylene, polyethylene or a combination thereof; and the separator is manufactured by stirring, mixing, cooling, extension, drawing out, drying and slitting;
the electrolyte comprises a lithium salt and an organic solvent; the organic solvent is a carbonate, a carboxylate, an ether or a combination thereof; the lithium salt is selected from the group consisting of the lithium perchlorate, anhydrous lithium tetrachloroaluminate, lithium hexafluorophosphate, lithium tetrafluoroborate, lithium bis(oxalate)borate, lithium oxalyldifluoroborate, lithium bis(fluorosulfonyl)imide, lithium bis(trifluoromethanesulfonyl)imide, lithium trifluoromethanesulfonate, lithium iodide and a combination thereof; the carbonate is selected from the group consisting of ethylene carbonate, propylene carbonate, 2,3-butylene carbonate, fluoroethylene carbonate, vinylene carbonate, dimethyl carbonate, ethyl methyl carbonate, diethyl carbonate and a combination thereof; the carboxylate is selected from the group consisting of methyl formate, ethyl formate, propyl formate, butyl formate, methyl acetate, ethyl acetate, propyl acetate, butyl acetate, methyl propionate, ethyl propanoate, propyl propionate, methyl butyrate, ethyl butyrate, propyl butyrate, 1,4-butyrolactone, δ-valerolactone and a combination thereof; and the ether is selected from the group consisting of 2-methyltetrahydrofuran, 1,3-dioxolane, 4-methyl-1,3-dioxolane, dimethoxymethane, 1,2-dimethoxyethane, diethylene glycol dimethyl ether and a combination thereof.

2. The primary lithium battery of claim 1, wherein the case is square or cylindrical, and is made of steel, aluminum or an aluminum-plastic material.

3. The primary lithium battery of claim 1, wherein the cathode material is selected from the group consisting of manganese dioxide, carbon-based manganese dioxide composite, sulfur, carbon-based sulfur composite, thionyl chloride and perfluorocarbon.

4. The primary lithium battery of claim 1, wherein the first conductive agent and the second conductive agent are independently selected from the group consisting of superconductive carbon black, conductive graphite, carbon fiber, carbon nanotube, grapheme and a combination thereof.

5. The primary lithium battery of claim 1, wherein the first binder and the second binder are independently selected from the group consisting of polyvinylidene chloride, styrene butadiene rubber, sodium carboxymethylcellulose and a combination thereof.

6. A method for preparing the primary lithium battery of claim 1, comprising:
(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a naked unit sub-cell; and covering an outer surface of the naked unit sub-cell with a film except for the positive sub-tab and the negative sub-tab to obtain a unit sub-cell;
(S2) welding positive sub-tabs of a plurality of unit sub-cells with a first metal sheet, and welding negative sub-tabs of the plurality of unit sub-cells with a second metal sheet to obtain a dry cell, wherein a part at an end of the first metal sheet is reserved to form a positive tab of the dry cell; a part at an end of the second metal sheet is reserved to form a negative tab of the dry cell; and the positive tab and the negative tab of the dry cell are respectively configured to be connected with an external current collector; and
(S3) placing the dry cell into the case followed by injection of the electrolyte, primary aging, sealing and secondary aging successively to produce the primary lithium battery.

7. A method for preparing the primary lithium battery of claim 1, comprising:
(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a naked unit sub-cell; and covering an outer surface of the naked unit sub-cell with a polyethylene film or a polypropylene film except for the positive sub-tab and the negative sub-tab to obtain a unit sub-cell, wherein a first air hole or a first air slit is formed on surface of the polyethylene film or the polypropylene film at ends near and far away from the positive sub-tab, and a second air hole or a second air slit is formed on the surface of the polyethylene film or the polypropylene film at ends near and far away from the negative sub-tab;
(S2) welding a negative sub-tab of a first unit sub-cell of a plurality of unit sub-cells and a positive sub-tab of a second unit sub-cell of the plurality of unit sub-cells to a first metal sheet; welding a negative sub-tab of the second unit sub-cell and a positive sub-tab of a third unit sub-cell of the plurality of unit sub-cells to a second metal sheet; welding a negative sub-tab of the third unit sub-cell and a positive sub-tab of a fourth unit sub-cell of the plurality of unit sub-cells to a third metal sheet, and so on, such that the plurality of unit sub-cells are connected in series to obtain a dry cell; wherein a positive sub-tab of the first unit sub-cell is configured as a positive tab of the dry cell, and a negative sub-tab of the last unit sub-cell of the plurality of unit sub-cells is configured as a negative tab of the dry cell; and the positive tab and the negative tab of the dry cell are respectively configured to be connected to an external current collector; and
(S3) placing the dry cell into the case followed by injection of the electrolyte, primary aging, sealing and secondary aging successively to produce the primary lithium battery.

8. A method for preparing the primary lithium battery of claim 1, comprising:
(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a naked unit sub-cell; and covering an outer surface of the naked unit sub-cell with a polyethylene film or a polypropylene film except for the positive sub-tab and the negative sub-tab to obtain a unit sub-cell, wherein a first air hole or a first air slit is formed on surface of the polyethylene film or the polypropylene film at ends near and far away from the positive sub-tab, and a second air hole or a second air slit is formed on the surface of the polyethylene film or the polypropylene film at ends near and far away from the negative sub-tab;
(S2) welding a negative sub-tab of a first unit sub-cell of a plurality of unit sub-cells and a positive sub-tab of a second unit sub-cell of the plurality of unit sub-cells to a first metal sheet; welding a negative sub-tab of the second unit sub-cell and a positive sub-tab of a third unit sub-cell of the plurality of unit sub-cells to a second metal sheet; welding a negative sub-tab of the third unit sub-cell and a positive sub-tab of a fourth unit sub-cell of the plurality of unit sub-cells to a third metal sheet, and so on, such that the plurality of unit sub-cells are connected in series to form a sub-cell set, wherein a positive sub-tab of the first unit sub-cell is configured as a positive branch-tab of the sub-cell set, and a negative sub-tab of the last unit sub-cell of the plurality of unit sub-cells is configured as a negative branch-tab of the sub-cell set;
(S3) welding positive branch-tabs of a plurality of sub-cell sets with a fourth metal sheet, and welding negative branch-tabs of the plurality of sub-cell sets with a fifth metal sheet to obtain a dry cell, wherein the plurality of sub-cell sets each have the same number of unit sub-cells; a part at an end of the fourth metal sheet is reserved to form a positive tab of the dry cell, and a part at an end of the fifth metal sheet is reserved to form a negative tab of the dry cell; and the positive tab and the negative tab of the dry cell are respectively configured to be connected with an external current collector; and
(S4) placing the dry cell into the case followed by injection of the electrolyte, primary aging, sealing and secondary aging successively to produce the primary lithium battery.

9. A method for preparing the primary lithium battery of claim 1, comprising:
(S1) subjecting a plurality of positive plates, a plurality of negative plates and a plurality of separators to lamination in a manner of repeated “positive plate-separator-negative plate-separator” or to lamination and winding; welding first reserved tabs of the plurality of positive plates to form a positive sub-tab, and welding second reserved tabs of the plurality of negative plates to form a negative sub-tab to obtain a unit sub-cell;
(S2) welding positive sub-tabs of a plurality of unit sub-cells with a first metal sheet, and welding negative sub-tabs of the plurality of unit sub-cells with a second metal sheet to obtain a naked sub-cell set, wherein a part at an end of the first metal sheet is reserved to form a positive branch-tab, and a part at an end of the second metal sheet is reserved to form a negative branch-tab; and covering an outer surface of the naked sub-cell set with a polyethylene film or a polypropylene film except for the positive branch-tab and the negative branch-tab to obtain a sub-cell set, wherein a first air hole or a first air slit is formed on surface of the polyethylene film or the polypropylene film at ends near and far away from the positive branch-tab, and a second air hole or a second air slit is formed on the surface of the polyethylene film or the polypropylene film at ends near and far away from the negative branch-tab;
(S3) welding a negative branch-tab of a first sub-cell set of a plurality of sub-cell sets and a positive branch-tab of a second sub-cell set of the plurality of sub-cell sets to a third metal sheet; welding a negative branch-tab of the second sub-cell set and a positive branch-tab of a third sub-cell set of the plurality of sub-cell sets to a fourth metal sheet; welding a negative branch-tab of the third sub-cell set and a positive branch-tab of a fourth sub-cell set of the plurality of sub-cell sets to a fifth metal sheet, and so on, such that the plurality of sub-cell sets are connected in series to obtain a dry cell, wherein the plurality of sub-cell sets each have the same number of unit sub-cells; a positive branch-tab of the first sub-cell set is configured as a positive tab of dry cell, and a negative branch-tab of the last sub-cell set is configured as a negative tab of the dry cell; and the positive tab and the negative tab are respectively configured to be connected with an external current collector; and
(S4) placing the dry cell into the case followed by injection of the electrolyte, primary aging, sealing and secondary aging successively to produce the primary lithium battery.
